(19) United States
(12) Patent Application Publication
(10) Pub. No.: US 2010/0102942 A1
(43) Pub. Date: Apr. 29, 2010

(54) Interior Fitting for a Motor Vehicle

(75) Inventors: Jochen Bisinger, Esslingen (DE); Dieter Reckels, Portland, OR (US); Holger Schleife, Stuttgart (DE); Kai Sieber, Portland, OR (US)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/257,229

(22) Filed: Oct. 23, 2008

(51) Int. Cl. B60Q 1/00

(52) U.S. Cl. 340/425.5

(57) ABSTRACT

A carrier supports a screen in an interior fitting for a motor vehicle, such as a driver's cab of a motor truck. The screen can be moved into two different positions relative to the carrier. In this way the screen can be used for various applications. The screen, for example, can be used for a television function or as a PC monitor.

### CROSS REFERENCE TO RELATED APPLICATIONS

Cross references are hereby made to commonly assigned U.S. patent application Ser. Nos. ______, ______, and ______ (Attorney docket nos. 60631US, 60629US, and 60628US), filed on the same date as the present application.

### BACKGROUND AND SUMMARY OF THE INVENTION

This invention relates to an interior fitting for a motor vehicle. The main application is in the driver's cab of a motor truck. The invention also relates to a motor truck with a driver's cab, in which the interior fitting is provided.

The invention further relates to the use of a screen in such a motor vehicle.

European document EP 0 423 349 A1 discloses how, in an aircraft or motor vehicle, a television receiver is arranged at a seat in such a way that it can rotate.

German document DE 102 26 405 C1 describes a facility for showing visual information in motor vehicles by means of a flat panel screen. The screen is mounted on a carrier. The entire carrier together with the screen is mounted in such a way that it can pivot. In order to move the flat panel screen into a useable position, it is necessary to first swivel the carrier into position, and then fold out the screen. The device serves the purpose of presenting the flat panel screen down from a vehicle roof even if this vehicle roof itself does not facilitate the suspension of a flat panel screen. The flat panel screen can be used in only one use position.

In terms of time, a truck driver spends a considerable part of his life in the motor truck. The driver is obliged by law to take longer breaks. There are demands for making available television in the driver's cab of a motor truck. A high degree of flexibility is desirable so as to additionally facilitate the use of computers.

Similar demands are also made in the mobile home sector as, also in this case, the occupants spend longer periods of time in the vehicle.

One object of this invention is to offer the occupants of a motor vehicle as many utilization options as possible, and to provide interior fittings with the largest possible number of technical features.

To achieve this object, the present invention proposes an interior fitting for a motor vehicle, including a screen and a carrier that supports the screen. In an extended position of the carrier, the screen can be moved at least into a first position relative to the carrier and a second position relative to the carrier. In the first position, the screen can be viewed from a first side defined with respect to the carrier, while, in the second position, the screen can be viewed from a second side defined with respect to the carrier. The invention also relates to a motor truck, which has a driver's cab equipped with such an interior fitting.

Again, at least in the extended position, the screen can be viewed from a first side of the carrier in the first position, and the screen can be viewed from the second side of the carrier in the second position of the screen.

In other words, the screen can be optionally adjusted in such a way that it can be used one time from a first direction and another time from a second direction. For example, the screen can be used once mainly as a television and then another time as a PC monitor.

When extended, the positions of the screen relative to the carrier are preferably defined exactly so that a first seating arrangement is assigned to the first position and a second seating arrangement is assigned to the second position. A person sitting in the first seating arrangement should be able to view the screen when it is in the first position, and a person sitting in the second seating arrangement should be able to view the screen when it is in the second position. The seating arrangements are preferably effected so that the viewing options of the person sitting in one of the seating arrangements are optimized, while the screen can only be viewed poorly or not at all from the other seating arrangement.

The first seating arrangement can constitute a swivel (passenger's or co-driver's) seat, preferably in a position where the person sitting in it is looking in the opposite direction of vehicle travel. It is therefore conceivable for the co-driver to use the screen as a computer monitor when a keyboard is correspondingly coupled to a processor unit and the monitor and the first two items are suitably supported.

The second seating arrangement can be a bunk. Typically, such a bunk is arranged in the driver's cab of a motor truck. The bunk should preferably be a bunk located behind the seats in the vehicle. In terms of dimensions, one dimension of the bunk can be longer than the other. Deviating from a conventional construction, in which the longer dimension is located transversely with respect to the direction of travel, this longer dimension is arranged preferably longitudinally with respect to the direction of travel. The direction defining the dimension should not deviate by more than 30° from the longitudinal axis of the vehicle at the point where the one dimension of the bunk is longer than the other.

In this way it is possible for a vehicle occupant to sit (or lie) on the bunk. For relaxation, the screen can be used as a television.

Preferably, the two positions are more or less precisely opposing positions. The second position is preferably reached by rotating through between 150° and 210° from the first position. The capability of the screen to rotate through such a large angle enables flexible utilization of the screen, e.g. as a PC monitor, when a person sits on the about-turned co-driver's seat, where the screen has a maximum distance of 1.50 m from the seat backrest. Another time, a user can lie on the bunk, view the screen from a distance, and use the screen for a television function. In both cases, the viewing direction of the user then approximately coincides with the longitudinal axis of the vehicle.

The carrier can be designed as a frame, and the screen can be mounted such that it swivels with respect to the frame. The position of the screen can then be adjusted in the frame, particularly if it is designed as a flat panel screen. The frame provides a sturdy hold for the screen and easily facilitates accommodation of a pivot axis for the screen, e.g. by means of opposing pins engaging in the screen at the underside of the frame and the top side of the frame, thus forming a pivot axis through the connecting line between the pins.

The entire frame is preferably designed in such a way that it can be swivelled. In this case, the extended position of the carrier will not be the only position; instead, there will be further positions. As a result, the frame with the screen can be optimally moved so that the screen can assume any required position in the room. The screen can also be moved into a position where it will not be in the way when not in use.

Preferably, the screen can be swivelled about an axis which is located parallel to the axis about which the frame is swivelled (or is inclined with respect to this axis by no more than 15°). These axes can be arranged parallel to the vertical axis of the vehicle so that the frame on the one hand and the screen on the other can be swivelled in one plane.

The pivot axis for the screen preferably passes through the screen at half its width. This means, when rotated through 180°, the screen essentially reassumes the same position in the frame as previously.

The extended position, in which the two positions of the screen can be defined relative to the carrier, can preferably be assumed from a rest position.

It has proven advantageous to locate the frame with the screen in a rest position in a recess in a flat wall in such a way that the surface of the screen lies in the same plane as the wall. This then forms a smooth continuous surface through the wall and screen. It should be possible to move the frame out of the rest position into the extended position.

It is possible for the screen to assume the first and second positions exclusively in the extended position. Preferably, however, the carrier (frame) can be simply moved from the extended position back into the rest position without changing the position of the screen relative to the carrier. The screen can then assume the first and second positions even with the carrier in a rest position. This arrangement can also be expanded so that, even with the carrier in the rest position, the screen can be moved from the one position into the other.

In this arrangement, two positions of the screen can be assigned with the carrier in the rest position. This arrangement may be set up in such a way that it is possible to view the screen in its first position with the carrier in rest position from the outside, while it is not possible to view the screen from the outside in the second position; instead, only the rear of the screen can be seen.

The invention is described in more detail in the following with reference to the drawings.

### BRIEF DESCRIPTION OF THE DRAWINGS

FIG. 1 shows a schematic representation of the interior fitting for a driver's cab of a motor truck in accordance with a first design layout of the invention with a carrier in a rest position,

FIGS. 2 and 3 show the interior fitting of FIG. 1 with the carrier in an extended position for a defined position of a screen supported by the carrier from two different directions,

FIG. 4 shows the carrier in an extended position with the position of the screen changed, and

FIG. 5 shows the rest position of the carrier with the screen in a different position compared to FIG. 1.

### DETAILED DESCRIPTION OF THE INVENTION

An entire interior fitting designated by reference number 10 is installed in the driver's cab 8 of a motor truck, illustrated schematically, through a doorway. A carrier 14, which supports a screen 16, is mounted on a wall 12 of the driver's cab. The carrier 14 is designed as a frame with two arms 18a, 18b. The arms 18a, 18b are mounted on the wall 12 by means of a pivot joint so that the entire carrier 14 can swivel about a pivot axis 19 (see arrow 20). This arrangement ensures that the carrier 14 can be swivelled from the wall 12 by an angle of up to 90° and not further. The extended position is reached when the carrier is fully folded out. In the extended position, it is possible to swivel the screen 16 about axis 22, which runs through the screen 16 at half its width.

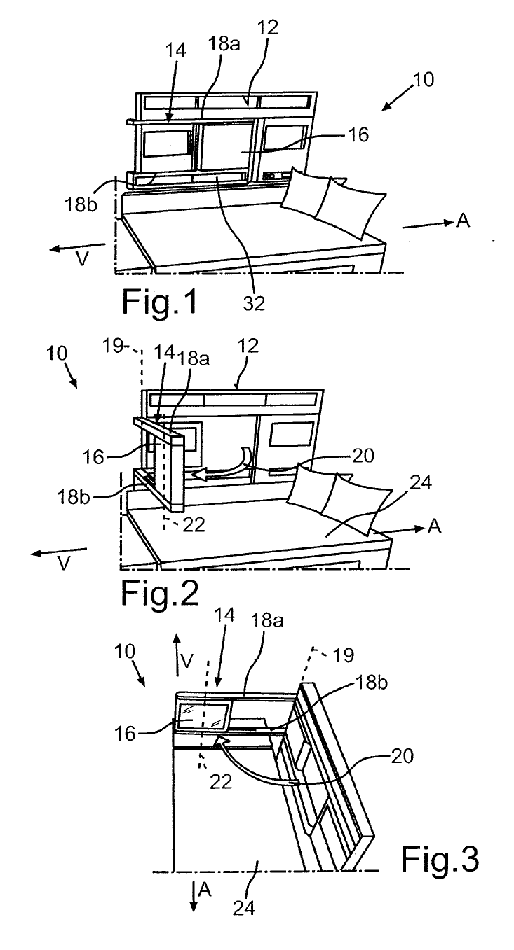

The situation shown in FIGS. 2 and 3 is established, starting from the rest position according to FIG. 1, in which the screen 16 (picture on the screen) cannot be viewed, and only the rear of the screen is visible. In this situation, a person sitting on a bunk 24 can view the screen, as is apparent, in particular, from FIG. 3. The bunk 24 is arranged in the driver's cab so that the defined position a person lying on the bunk 24 takes up is such that the axis of the body coincides with the longitudinal axis A of the vehicle. Instead of looking out of the windscreen of the driver's cab, the person lying on the bunk 24 looks at the screen 16.

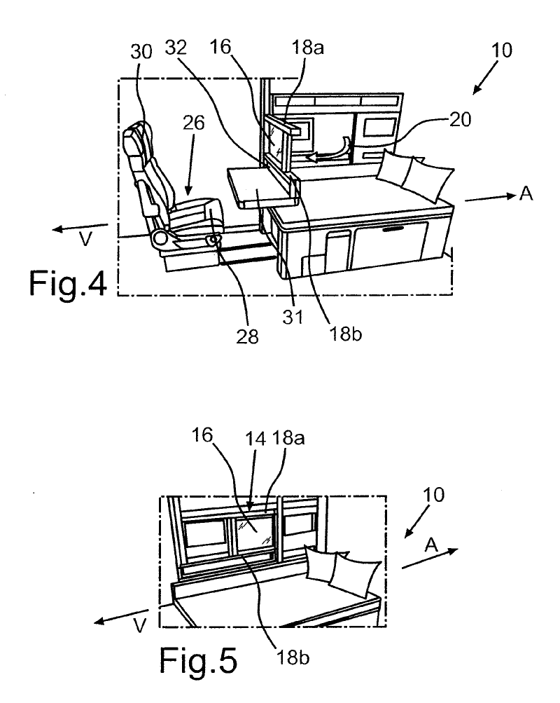

FIG. 4 illustrates the situation in which, based on the position shown in FIGS. 2 and 3, the screen has been turned through 180°. The screen can now be viewed when an occupant positions himself in such a way that he again looks along the longitudinal axis A of the vehicle. This situation is made possible by swiveling a seat 26, in this case the co-driver's seat 26 in the driver's cab, such that the seat cushion 28 is arranged behind the backrest 30 of seat 26 with respect to the axis of the vehicle. A person sitting on the seating arrangement 26 therefore looks towards the rear in the direction of the longitudinal axis A of the vehicle, and therefore exactly at the screen 16. The screen 16 is situated relatively close to a person sitting in the seat 26, and in this situation, it is preferably used as a monitor for a personal computer. A corresponding connection facility (not illustrated) should be provided. The frame can be supported on a table 31, e.g. by means of a support unit 32, which is also pivoted from the wall 12.

Based on the position shown in FIG. 4, the carrier 14 can be swivelled back again by 90°. Unlike in the rest position shown in FIG. 1, it is possible to view the screen 16 in the position illustrated in FIG. 5. It is then possible to watch television from another side of the vehicle, e.g. from the driver's seat (not illustrated), which is correspondingly turned, or from a further bunk, for example a raised bunk (not illustrated) arranged transversely with respect to the longitudinal axis A of the vehicle.

The combination of the pivoted carrier 14 and the screen 16 pivoted with respect to the carrier creates a large number of possible applications for the screen.

Although modifications and changes may be suggested by those skilled in the art, it is the intention of the inventor to embody within the patent warranted hereon all changes and modifications as reasonably and properly come within the scope of his contribution to the art.

We claim

1. An interior fitting for a motor vehicle, comprising:
a screen, and
a carrier that supports the screen,
wherein, in an extended position of the carrier, the screen can be moved at least into a first position relative to the carrier and a second position relative to the carrier,
wherein the screen, in the first position, can be viewed from a first side defined with respect to the carrier, and
wherein the screen, in the second position, can be viewed from a second side defined with respect to the carrier.

2. The interior fitting in accordance with claim 1, wherein a first seating arrangement is assigned to the first position of the screen with the carrier in the extended position so that a person sitting in the first seating arrangement can view the screen when it is in the first position, and wherein a second seating arrangement is assigned to the second position of the screen with the carrier in the extended position so that a person sitting in the second seating arrangement can view the screen when it is in the second position.

3. The interior fitting in accordance with claim 2, wherein the first seating arrangement constitutes a swivel seat when it is in such a position that a person sitting in it looks in the direction opposite the forward travel direction of the motor vehicle.

4. The interior fitting in accordance with claim 2, wherein the second seating arrangement is a bunk.

5. The interior fitting in accordance with claim 1, wherein the second position is achieved by rotating the screen through between 150° and 210° from the first position.

6. The interior fitting in accordance with claim 1, wherein the carrier is designed as a frame and the screen can be swivelled with respect to the frame.

7. The interior fitting in accordance with claim 6, wherein the frame is pivoted, and wherein the screen can be swivelled about an axis, arranged parallel to another axis about which the frame can be pivoted.

8. The interior fitting in accordance with claim 6, wherein a pivot axis for the screen passes through this screen at half its width.

9. The interior fitting in accordance with claim 6, wherein the carrier with the screen in a rest position is located in a recess in a flat wall in such a way that a surface of the screen lies on the same plane as the wall, and wherein the frame can be moved out of the rest position into the extended position.

10. The interior fitting in accordance with claim 1, wherein the screen can assume the first and second positions with respect to the carrier in a rest position.

11. The interior fitting in accordance with claim 10, wherein the carrier can be moved out of the extended position into the rest position in both positions of the screen.

12. A motor truck with a driver's cab in which an interior fitting in accordance with claim 1 is installed.

13. The interior fitting in accordance with claim 1, wherein the interior fitting is for a driver's cab of a motor truck.

14. The interior fitting in accordance with claim 7, wherein said axis about which the screen can be swivelled passes through the screen at half its width.

15. A motor truck with a driver's cab in which an interior fitting in accordance with claim 2 is installed.

16. A motor truck with a driver's cab in which an interior fitting in accordance with claim 3 is installed.

17. A motor truck with a driver's cab in which an interior fitting in accordance with claim 4 is installed.

18. A motor truck with a driver's cab in which an interior fitting in accordance with claim 5 is installed.

19. A motor truck with a driver's cab in which an interior fitting in accordance with claim 6 is installed.

20. A motor truck with a driver's cab in which an interior fitting in accordance with claim 7 is installed.
